(19) United States
(12) Patent Application Publication
(10) Pub. No.: US 2011/0231852 A1
(43) Pub. Date: Sep. 22, 2011

(54) METHOD AND SYSTEM FOR SCHEDULING MEDIA EXPORTS

(76) Inventors: Parag Gokhale, Ocean, NJ (US); Rajiv Kottomtharayil, Ocean, NJ (US); Srinivas Kavuri, Highland Park, NJ (US)

(21) Appl. No.: 13/149,546

(22) Filed: May 31, 2011

Related U.S. Application Data
(63) Continuation of application No. 09/991,900, filed on Nov. 23, 2001, now abandoned.

(51) Int. Cl. G06F 9/46

(52) U.S. Cl. 718/102

(57) ABSTRACT

Methods, systems and software components are described for exporting media in a library according to a schedule. At a first time, a user provides and a system receives export identification data including data identifying one or more media from the library to be exported and data identifying a second time at which the one or more media is scheduled to be exported. The first data may be a list of media identified by media identifiers and related data or may be a set of one or more criteria which are evaluated to determine which media in the library should be exported at the scheduled time. The export identification data is stored in a relational database table. At the second, scheduled time, the stored export identification data is used to select the one or more media to be exported to export the selected media from the library.

### CROSS-REFERENCE TO RELATED APPLICATION(S)

This application is a continuation of U.S. patent application Ser. No. 09/991,900 filed Nov. 23, 2001, entitled “METHOD AND SYSTEM FOR SCHEDULING MEDIA EXPORTS,” which is incorporated herein by reference in its entirety.

This application is related to the following pending applications, each of which is hereby incorporated herein by reference in its entirety:

application Ser. No. 09/610,738, titled MODULAR BACKUP AND RETRIEVAL SYSTEM USED IN CONJUNCTION WITH A STORAGE AREA NETWORK, filed Jul. 6, 2000, attorney docket number 044463-002;

application Ser. No. 09/609,977, titled MODULAR BACKUP AND RETRIEVAL SYSTEM WITH AN INTEGRATED STORAGE AREA FILING SYSTEM, filed Jul. 5, 2000, attorney docket number 044463-0023;

application Ser. No. 09/354,058, titled HIERARCHICAL BACKUP AND RETRIEVAL SYSTEM, filed Jul. 15, 1999, attorney docket number 044463-0014;

application Ser. No. ______, titled LOGICAL VIEW AND ACCESS TO PHYSICAL STORAGE IN MODULAR DATA AND STORAGE MANAGEMENT SYSTEM, filed Jan. 30, 2001, attorney docket number 044463-0035.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

The invention disclosed herein relates to computer backup systems and, more particularly, to systems for administering computer backups and controlling media libraries.

Computer systems are often backed up by storing copies of data in computer memory devices to more long term storage devices. Such backup storage devices typically include a number of magnetic tapes or optical disks contained in large libraries or cabinets. When a given tape or disk, generally referred to herein as media, is full or close to full, and will not be erased, overwritten, or otherwise reused, the media needs to be removed or exported from the library and replaced with a new media for receiving new data from the computer system.

These libraries or storage cabinets often contain automated arms for moving media around during a backup copy process or when a given media is full. Current computer backup systems allow users to send a control signal to a library to export a specified tape or disk, which causes the library's automated arm to immediately grab the media and place it in a bin accessible to a person who may then remove the disk for storage in a safe location. Since the library may be physically remote from the administrator performing the backup, this often results in a delay in exporting media, as the administrator must make special arrangements for another person to be present to remove the exported media and make a new media available to the library. This is particularly problematic when administrators perform their backups at night, as is frequently done to avoid taking up computer system resources during the backup operation.

There is therefore a need for systems and methods for providing improved administration of media exports.

### SUMMARY

In accordance with embodiments of the present invention, a method is provided for exporting media in a library according to a schedule. The method includes at a first time, receiving export identification data comprising first data identifying one or more media from the library to be exported and second data identifying a second time at which the one or more media is scheduled to be exported. The first data may be a list of media identified by media identifiers and related data. The first data may alternatively be a set of one or more criteria which are evaluated to determine which media in the library should be exported at the scheduled time. The export identification data is stored in a data file. At the second, scheduled time, the stored export identification data is used to select the one or more media to be exported to export the selected media from the library.

When the first data consists of media selection criteria, these criteria are evaluated at or before the scheduled time to produce a list of media to be exported. Users may edit this list. In addition, a combination of listed media and criteria may be specified in the first data, in which case the media selected through evaluation of the criteria would be added to the list of specified media. Any conditions or expressions may be used as the criteria, such as how full a media is after a backup operation or the length of time since a media was last read from or written to.

The data file used may be any type of file, including a flat file, a database file, a relational database table, etc. the data file or a second data file may be used to further store a filed indicating the status of the export of each media. This field is updating during or following a scheduled export operation. Export operations may be halted or delayed during execution, which is reflected in this export status field.

These methods may be executed by one or more computers executing software programs stored in memory devices.

In accordance with further embodiments, the present invention is an administrative system for scheduling an export of one or more media from a library. The system contains a user interface for receiving, at a first time, export identification data comprising first data identifying one or more media from the library to be exported and second data identifying a second time at which the identified one or more media is scheduled to be exported, a data file stored in a memory device for storing the export identification data, and a task control subsystem for retrieving the export identification data at the second time from the data file and controlling the library to cause the export of the media identified by the media identification data.

Further in accordance with embodiments of the present invention, a data structure is provided stored on a computer readable medium. The data structure comprises first data identifying one or more media from a media library and second data identifying a time at which the identified one or more media are scheduled to be exported from the library, the data structure being accessed by a task control application program at the second time to determine which one or more media are scheduled to be exported at the second time and to send a control signal to the media library to initiate export of the identified one or more media.

### BRIEF DESCRIPTION OF THE DRAWINGS

FIG. 1 is a block diagram showing a system for scheduling media exports in accordance with one embodiment of the present invention;

FIG. 2 is a flow chart showing a process for scheduling media exports using the system of FIG. 1 in accordance with one embodiment of the present invention;

FIGS. 3A-3B contain a flow chart showing the process of FIG. 2 in greater detail in accordance with one embodiment of the present invention;

FIG. 4 is an exemplary screen display allowing a user to select whether schedule an export by listing media or selecting one or more criteria;

FIG. 5 is an exemplary screen display allowing a user to list media for scheduled export; and

FIGS. 6 and 7 are exemplary screen displays allowing a user to select one or more criteria for media selection for scheduled export.

### DETAILED DESCRIPTION

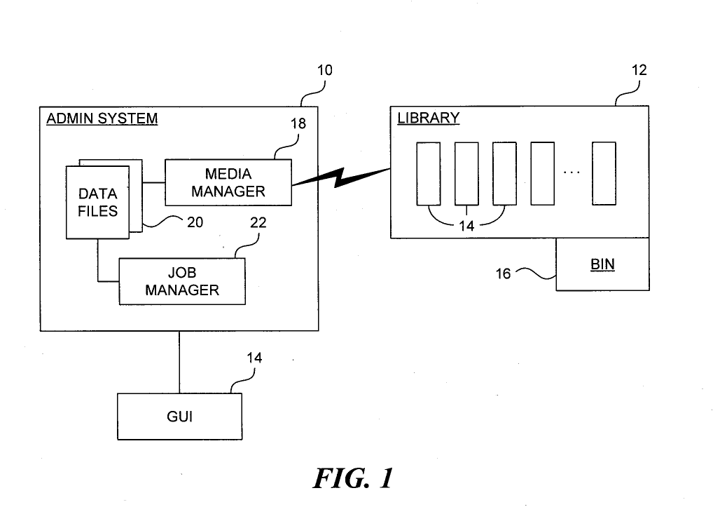

Preferred embodiments of the present invention are now described with reference to the drawings in FIGS. 1-7. As shown in FIG. 1, an administrative system 10 is connected to a media library 12 and a graphical user interface 14 available through a computer. The administrative system 10 may be a stand-alone system including a computer and software, or may be part of a computer backup and storage system. The library 12 contains multiple media 14 such as magnetic tapes, optical disks, or other storage media. The library 12 has a mechanism such as an automated arm capable of handling and moving the media around 14 the library 12. The library further contains a bin 16 into which one or more media may be placed or exported for removal by a person or machine and safe storage at a secure location.

The administrative system 10 of one embodiment contains a media manager component 18, a number of data files 20 stored in memory, and a job manager component 22. The media manager 18 is a software program which controls the media used in the library during a backup operation and also controls exporting or replacement of media. The data files 20 are any conventional data files such as database files, relational database tables, flat files, etc., and store data relating to, among other things, media to be exported and a time at which the media are scheduled for export. Embodiments of the data files 20 are described in greater detail below. The job manager 22 is a software component programmed, among other things, to manage backup tasks and processes.

The graphical user interface 14 provides users with access to the administrative system 10. The GUI 14 allows users to input the data needed to support scheduled exports of media from the library, as described further below.

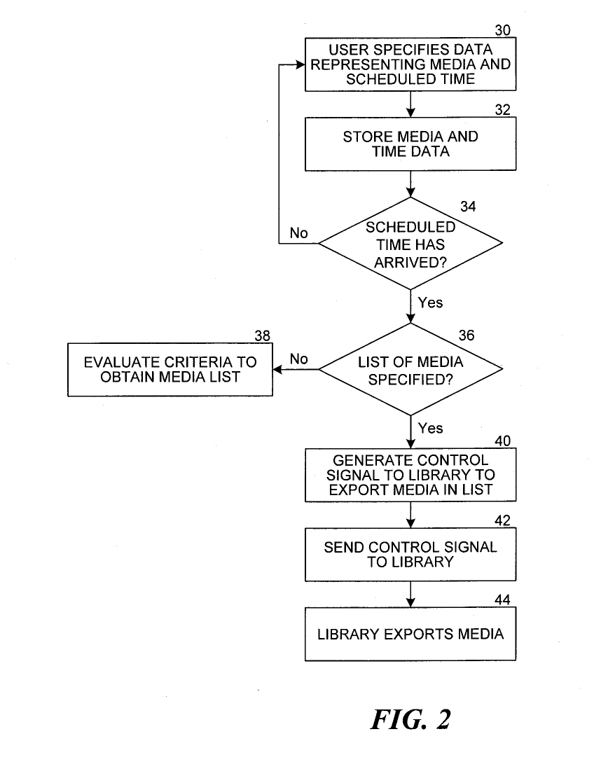

A process of one embodiment for scheduling media exports using the system of FIG. 1 is shown at a high level in FIG. 2. A user specifies data representing media and a scheduled time for exports, step 30. As described further below, the input data may be a list of media or one or more media selection criteria. The input media and time data is stored in a data file, step 32. Until the scheduled time arrives, the user can continue to input additional data or modify the data already input. When the scheduled time arrives, step 34, a media list is obtained. If the user specified the media list, step 36, that list is retrieved from the stored data file. If criteria were specified, the criteria are evaluated to determine which media meet the criteria and are thus ready to be exported, step 38. The admin system then generates a control signal to be sent to the library to export the media in the list, step 40. This signal is sent to the library, step 42, which then exports the media for removal and replacement, step 44.

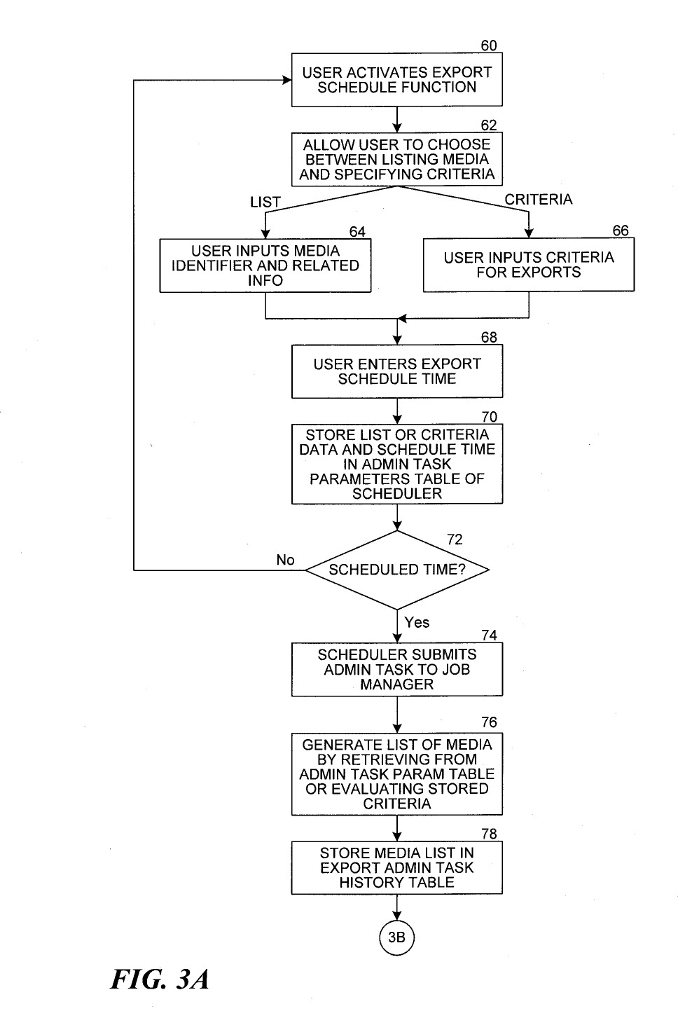

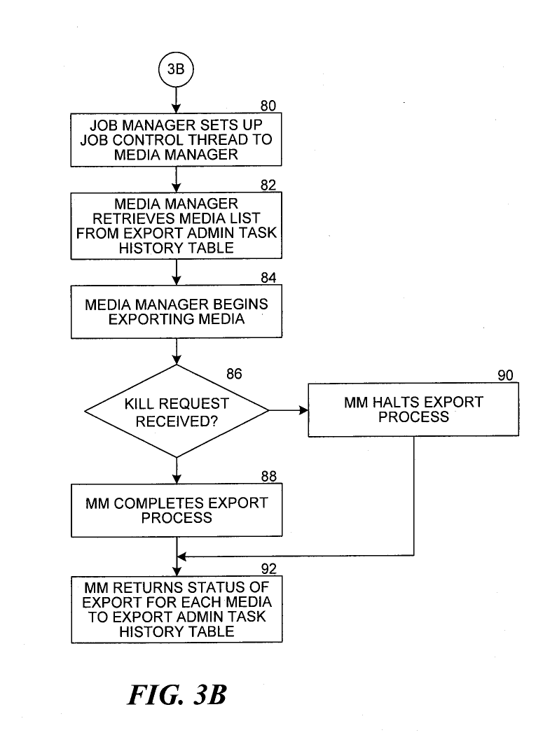

As will be recognized by those of skill in the art, this system and process may be implemented with any computer backup and storage system. FIGS. 3A-3B contain a flow chart and FIGS. 4-7 contain exemplary screen displays showing a particular embodiment of this process as implemented in the architecture of the GALAXY backup system available from Comm Vault Systems Inc., owner of the present application. The GALAXY system architecture is described in the commonly owned patent applications listed above and incorporated herein by reference.

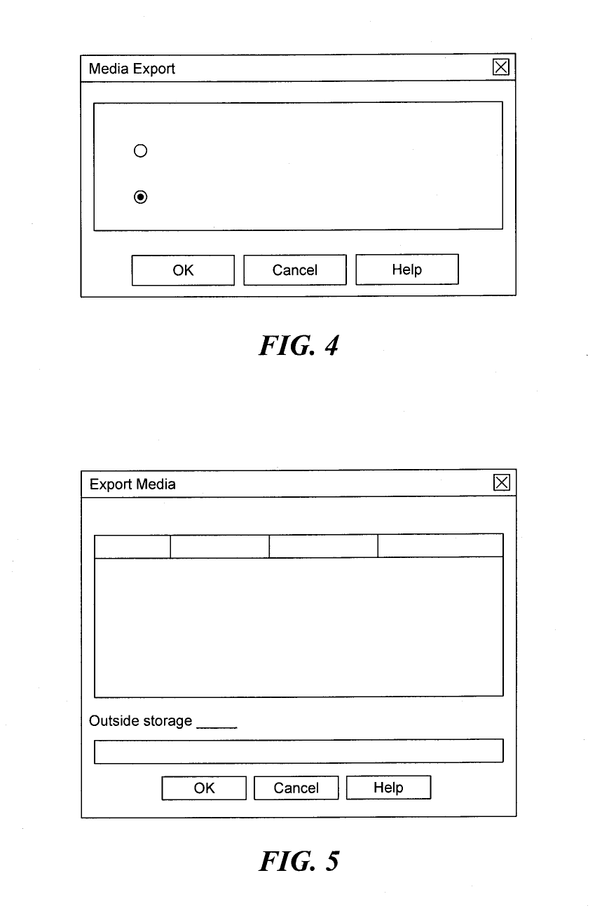

When using the GALAXY system, the user activates the export scheduler function, step 60, by, for example, selecting an option while working in the library level. The user is allowed to choose between entering a list of media or specifying criteria for media selection, step 62. This choice may be made through a dialog with radio button selection such as is shown in the screen display in FIG. 4. If the user selects the list option, the user is shown a list of all media residing in the library and is prompted to select any number of media from the list, step 64. An exemplary dialog structure for this list presentation is shown in FIG. 5. The user is further given the option of exporting the media now or scheduling the export for a later time, and enters the time for the scheduled export, step 68.

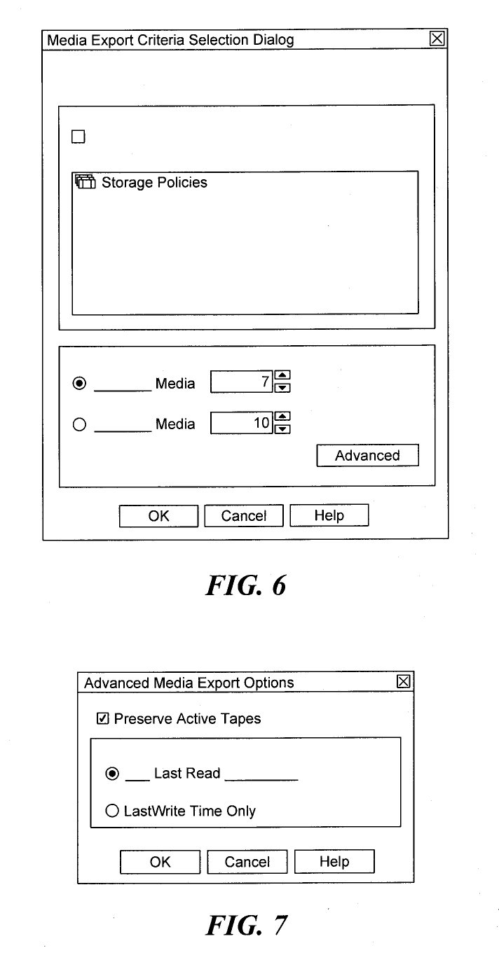

If the user selects the criteria option, the user inputs the desired criteria to be used to generate a list of media for export, step 66. Exemplary screen displays for entering criteria are shown in FIGS. 6 and 7. As shown in FIG. 6, the user may select a storage policy, described in the above referenced applications, as the basis for the media selection criteria. The user may alternatively select a criteria based on how old the media is and how many media should be exported. In addition, as shown in FIG. 7, the user may choose to limit exports to those media which are active, and may define activity based on the last time the media has been read from and/or written to. Other criteria may be used within the scope of the invention. The Media Manager is then queried by a criteria evaluation routine to determine which media currently satisfy the criteria, and a list may be presented to the user, if desired. The user may then choose some or all of the media returned from the media manager for a scheduled export. Alternatively, the user may choose the media selection criteria, which would be reevaluated at the scheduled time, which is entered, step 68.

The scheduled time and media list or media selection criteria are stored in an admin task parameters table for a scheduler component, step 70. The scheduler monitors the time so that, when the scheduled time arrives, step 72, it submits an admin task to the job manager, step 74, and passes a task ID. The job manager based on the type of export generates a list of media for export, step 76, and stores it in an export admin task history table, step 78. If the admin task parameters table contains media selection criteria, the job manager generates the media list by calling the criteria evaluation routine as explained above. The export admin task history table a jobID, one or more media identifiers corresponding to the selected media, and a filed indicating the export status of each media identifier. In one embodiment, the export status may have one of four states, including idle, in transit, exported, or export failed. There may also be a reason field for memos explaining the export status.

When the job manager receives the request for an export admin job, the job manager starts a process and passes on the job id. This process sets up a job control thread call to a media manager client API, step 80, to execute the bulk export. The media manager takes in a job ID as the input parameter for the client API, queries the table, and accumulates a list of media Ids, step 82. The media manager begins processing the bulk export for these media, step 84. During the bulk exports, an administrator may request the exports cease. If no such kill request is received, step 86, the media manager completes the export process, step 88. If a kill request is received, the export process is stopped, step 90. On completion or interruption of the export, the media manager returns a status for the export request and updates in the export admin task history table the status of each media being exported and already exported, step 92.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

I/We claim:

1. A method of exporting removable media from a media library according to a schedule, wherein the library comprises a mechanism for handling and physically moving media, the method comprising:
at a first time, receiving export identification data comprising first data for identifying one or more removable media from the media library to be exported;
at the first time, receiving second data identifying a second time at which the one or more removable media is scheduled to be exported, wherein the first time and the second time differ by at least one day;
storing the export identification data in a data file;
at the second time, using the stored export identification data to select the one or more removable media to be exported; and
sending a control signal to the library to cause the handling mechanism to physically export the selected media from the media library at the second time when the selected media is scheduled to be exported.

2. The method of claim 1, wherein receiving export identification data comprises receiving a list of one or more removable media.

3. The method of claim 2, wherein receiving a list of one or more removable media comprises receiving a list of removable media identifiers.

4. The method of claim 1, wherein receiving export identification data comprises receiving one or more removable media selection criteria.

5. The method of claim 4, wherein using the stored export identification data to select the one or more removable media to be exported comprises evaluating the stored removable media selection criteria to determine which of the removable media in the media library meets the one or more removable media selection criteria.

6. The method of claim 4, wherein receiving one or more removable media selection criteria comprises receiving a criteria defined by a length of time since a removable media was last read from or written to.

7. The method of claim 1, wherein storing the export identification data comprises storing the export identification data in an administrative task parameter table.

8. The method of claim 7, comprising accessing the administrative task parameter table at the second time to retrieve the identification data.

9. The method of claim 1, comprising storing an export history table containing a plurality of fields identifying the removable media to be exported and a status of the export of each such removable media.

10. The method of claim 9, comprising updating the export history table following an attempt to export the removable media from the storage device.

11. The method of claim 1, comprising receiving an instruction to halt or delay an export and halting or delaying the export.

12. A system for scheduling and exporting one or more removable media from a media library, the system comprising:
a mechanism in the library for physically handling and moving media;
a user interface for receiving, at a first time, export identification data comprising first data for identifying one or more removable media from the media library to be exported and second data identifying a second time at which the identified one or more removable media is scheduled to be exported, wherein the first time and the second time differ by at least one day;
a data file stored in a memory device for storing the export identification data; and
a task control subsystem configured to retrieve the export identification data at the second time from the data file and send a control signal to the media library to cause the handling mechanism to physically export the removable media identified by the media identification data at the second time when the selected media is scheduled to be exported.

13. The system of claim 12, wherein the user interface is configured to allow a user to specify one or more removable media to be exported by one or more respective removable media identifiers, the data file storing the specified removable media identifiers.

14. The system of claim 12, wherein the user interface is configured to allow a user to specify one or more criteria by which removable media is selected to be exported, the database storing the specified one or more criteria.

15. The system of claim 14, wherein the task control subsystem comprises an evaluator for evaluating the stored criteria to determine which one or more removable media in the media library satisfy the specified one or more criteria at the second time.

16. The system of claim 12, comprising an export history data file stored in a memory device, the export history data file containing a field associated with each removable media indicating a status of the export of the removable media.

17. The system of claim 12, wherein the user interface is configured to allow a user to specify second data comprising a specified event following which the removable media is to be exported.

18. A non-transitory computer readable medium storing instruction, which when executed by at least one computing device, performs a method of exporting removable media from a media library according to a schedule, wherein the library comprises a mechanism for handling and physically moving media, the method comprising:
at a first time, receiving export identification data comprising first data for identifying one or more removable media from the media library to be exported;
at the first time, receiving second data identifying a second time at which the one or more removable media is scheduled to be exported, wherein the first time and the second time differ by at least one day;
storing the export identification data in a data file;
at the second time, using the stored export identification data to select the one or more removable media to be exported; and
sending a control signal to the library to cause the handling mechanism to physically export the selected media from the media library at the second time when the selected media is scheduled to be exported.

19. The computer-readable medium of claim 18, wherein the first data comprises a list of one or more removable media identifiers.

20. The computer-readable medium of claim 19, wherein the first data comprises one or more criteria by which one or more removable media is selected to be exported at the second time.
